(19) United States
(12) Patent Application Publication
(10) Pub. No.: US 2015/0242876 A1
(43) Pub. Date: Aug. 27, 2015

(54) METHOD AND SYSTEM FOR PROVIDING AN INVESTMENT FUND FOR CONSUMER REWARDS

(71) Applicant: MasterCard International Incorporated, Purchase, NY (US)

(72) Inventors: Jeremy PASTORE, Brooklyn, NY (US); Michael Zhao, New York, NY (US)

(73) Assignee: MasterCard International Incorporated, Purchase, NY (US)

(21) Appl. No.: 14/189,163

(22) Filed: Feb. 25, 2014

(51) Int. Cl. G06Q 30/02

(52) U.S. Cl. CPC G06Q 30/0216; G06Q 30/0226

(57) ABSTRACT

A method for investing consumer loyalty rewards includes: storing, in a rules database, one or more conversion rules, wherein each of the one or more conversion rules includes at least an account identifier and a conversion rate; receiving, by a receiving device, an investment request, wherein the investment request includes at least a specific account identifier and a reward amount; identifying, in the rules database, a specific conversion rule where the included account identifier corresponds to the specific account identifier; calculating, by a processing device, a monetary value based on application of the conversion rate included in the specific conversion rule to the reward amount included in the received investment request; and transmitting, by a transmitting device, an investment request, wherein the investment request includes at least the calculated monetary value and requests investment of the calculated monetary value in one or more investment accounts.

### FIELD

The present disclosure relates to the investing of consumer reward points, specifically the conversion of consumer reward points to and from an investment to provide a return on rewards for consumers.

### BACKGROUND

Consumer reward systems, such as reward points, are used by many issuing banks and other financial institutions to provide an incentive for a consumer to use one payment method over another. In many instances, a consumer may use a payment card or other payment instrument to fund a payment transaction, and receive a number of points or other rewards based on the transaction amount and other considerations. The consumer may accumulate these points over time and redeem them for products, cash back, or other benefits.

However, there may often times be consumers that go long periods of time between redemptions for their reward points. As a result, the consumer's points may sit in an account unused. It may be of interest to issuers and other financial institutions that offer points to provide for some benefit for instances where points accumulate between redemptions. With this in mind, the present inventors believe there is a need for a technical solution to provide an investment fund for accumulated consumer rewards to benefit consumers and issuers.

### SUMMARY

The present disclosure provides a description of systems and methods for investing and conversion thereof of consumer loyalty rewards.

A method for investing consumer loyalty rewards includes: storing, in a rules database, one or more conversion rules, wherein each of the one or more conversion rules includes at least an account identifier and a conversion rate; receiving, by a receiving device, an investment request, wherein the investment request includes at least a specific account identifier and a reward amount; identifying, in the rules database, a specific conversion rule where the included account identifier corresponds to the specific account identifier; calculating, by a processing device, a monetary value based on application of the conversion rate included in the specific conversion rule to the reward amount included in the received investment request; and transmitting, by a transmitting device, an investment request, wherein the investment request includes at least the calculated monetary value and requests investment of the calculated monetary value in one or more investment accounts.

A method for converting an investment to consumer loyalty rewards includes: storing, in a rules database, one or more conversion rules, wherein each of the one or more conversion rules includes at least a rule identifier and a conversion rate; storing, in an investment database, a plurality of investment data entries, wherein each investment data entry includes data related to an investment including at least an account identifier, a specific rule identifier, and an invested amount; receiving, by a receiving device, a conversion request, wherein the conversion request includes at least a specific account identifier; identifying, in the investment database, a specific investment data entry where the included account identifier corresponds to the specific account identifier included in the received conversion request; identifying, in the rules database, a specific conversion rule where the included rule identifier corresponds to the specific rule identifier included in the identified specific investment data entry; calculating, by a processing device, a reward amount based on application of the conversion rate included in the identified specific conversion rule to the invested amount included in the identified specific investment data entry; and transmitting, by a transmitting device, at least the calculated reward amount in response to the received conversion request.

A system for investing consumer loyalty rewards includes a rules database, a receiving device, a processing device, and a transmitting device. The rules database is configured to store one or more conversion rules, wherein each of the one or more conversion rules includes at least an account identifier and a conversion rate. The receiving device is configured to receive an investment request, wherein the investment request includes at least a specific account identifier and a reward amount. The processing device is configured to: identify, in the rules database, a specific conversion rule where the included account identifier corresponds to the specific account identifier′ and calculate a monetary value based on application of the conversion rate included in the specific conversion rule to the reward amount included in the received investment request. The transmitting device is configured to transmit an investment request, wherein the investment request includes at least the calculated monetary value and requests investment of the calculated monetary value in one or more investment accounts.

A system for converting an investment to consumer loyalty rewards includes a rules database, an investment database, a receiving device, a processing device, and a transmitting device. The rules database is configured to store one or more conversion rules, wherein each of the one or more conversion rules includes at least a rule identifier and a conversion rate. The investment database is configured to store a plurality of investment data entries, wherein each investment data entry includes data related to an investment including at least an account identifier, a specific rule identifier, and an invested amount. The receiving device is configured to receive a conversion request, wherein the conversion request includes at least a specific account identifier. The processing device is configured to: identify, in the investment database, a specific investment data entry where the included account identifier corresponds to the specific account identifier included in the received conversion request; identify, in the rules database, a specific conversion rule where the included rule identifier corresponds to the specific rule identifier included in the identified specific investment data entry; and calculate a reward amount based on application of the conversion rate included in the identified specific conversion rule to the invested amount included in the identified specific investment data entry. The transmitting device is configured to transmit at least the calculated reward amount in response to the received conversion request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for converting consumer rewards into an investment and conversion of the investment back into consumer rewards in accordance with exemplary embodiments.

FIG. 2 is a block diagram illustrating the processing server of FIG. 1 for the conversion of consumer loyalty rewards to and from an investment fund in accordance with exemplary embodiments.

FIGS. 3A and 3B are a flow diagram illustrating a process for investing consumer loyalty rewards in accordance with exemplary embodiments.

FIGS. 4A and 4B are a flow diagram illustrating a process for converting an investment fund into consumer loyalty rewards in accordance with exemplary embodiments.

FIG. 5 is a flow diagram illustrating a method for converting consumer loyalty rewards to and from an investment fund using the processing server of FIG. 2 in accordance with exemplary embodiments.

FIG. 6 is a diagram illustrating a graphical user interface for the conversion of consumer loyalty rewards to and from an investment by a consumer in accordance with exemplary embodiments.

FIG. 7 is a flow chart illustrating an exemplary method for investing consumer loyalty rewards in accordance with exemplary embodiments.

FIG. 8 is a flow chart illustrating an exemplary method for converting an investment to consumer loyalty rewards in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

Definition of Terms

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Investing Consumer Loyalty Rewards

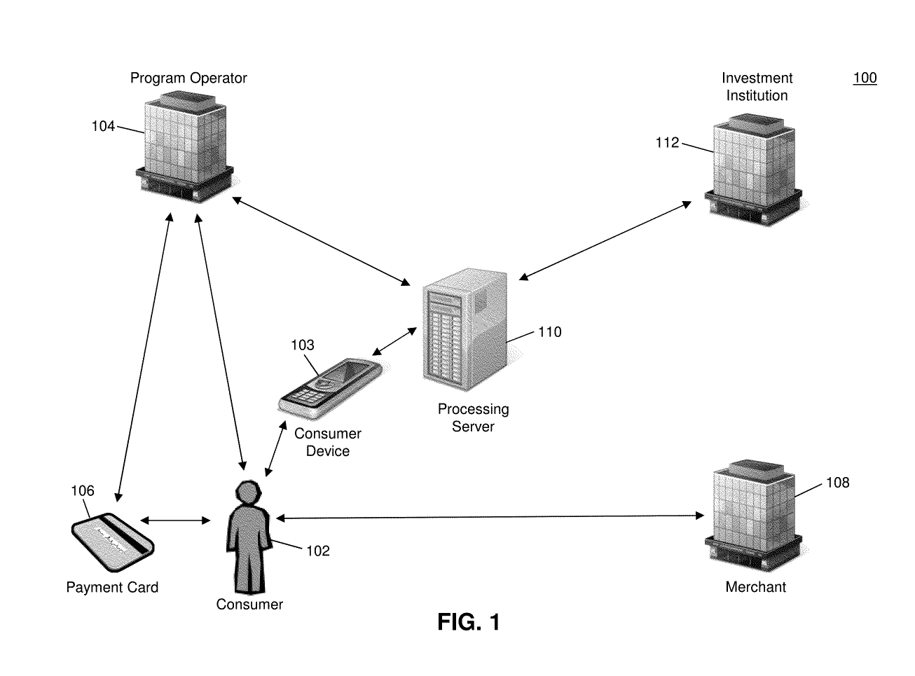

FIG. 1 illustrates a system 100 for the investment of consumer loyalty rewards into an investment fund and conversion thereof back into consumer loyalty rewards.

The system 100 may include a consumer 102. The consumer 102 may be associated with one or more payment accounts held by a program operator 104. The program operator 104 may be an issuing bank or other suitable financial institution or entity configured to hold payment accounts for consumers, such as the consumer 102. The program operator 104 may issue a payment card 106 to the consumer 102 for one or more payment accounts to which the consumer 102 is associated. The payment card 106 may be issued on a payment account for which consumer loyalty rewards (e.g., points) or other suitable reward program are provided for use of the payment card 106 to fund payment transactions.

In an example, the consumer 102 may conduct a payment transaction with a merchant 108 for the purchase of goods or services. As part of the payment transaction, the consumer 102 may provide the payment card 106 to the merchant 108 to pay for the transaction. The merchant 108 may read payment details from the payment card 106, which may be included in an authorization request for the payment transaction. The transaction may then be processed using methods and systems that will be apparent to persons having skill in the relevant art. In some embodiments, the merchant 108 and the program operator 104 may be a single entity. For example, in such an embodiment, the merchant 108 may issue the payment card 106 to the consumer 102 and operate a rewards program for the issued payment card 106. Additionally, the payment card might be issued by and transactions processed by another entity, and the program operator 104 would maintain the loyalty program.

As part of the processing, the program operator 104 may approve of the use of the payment card 106 (e.g., by checking for an adequate balance in the associated payment account) and may then calculate a point value based on transaction data and award the consumer 102 with a corresponding number of points. It will be apparent to persons having skill in the relevant art that, although examples illustrated and discussed herein may use points as being illustrative of a consumer loyalty reward for use in the methods and systems discussed herein, other suitable types of consumer loyalty rewards may be used.

The system 100 may also include a processing server 110. The processing server 110, discussed in more detail below, may be configured to provide the consumer 102 with an opportunity to invest their reward points in an investment fund. The consumer 102 may register with the processing server 110 via a consumer device 103 to use their service. The consumer device 103 may be any type of device suitable for performing the functions as disclosed herein, such as a desktop computer, laptop computer, tablet computer, cellular phone, smart phone, etc. The consumer 102 may register using the consumer device 103 via an application program stored on and executed by the consumer device 103, such as an application program developed by or on behalf of the processing server 110 (e.g., or an entity thereof) or a web browsing application configured to navigate to a webpage via which the consumer 102 may register with the service.

The consumer device 103 may transmit registration data provided by the consumer 102 to the processing server 110, which may include one or more payment accounts to which the consumer 102 is authorized. As part of the registration, the processing server 110 may verify the payment account(s) of the consumer 102 with the program operator 104 to identify that the consumer 102 is authorized to access the reward points of the payment account(s) and to identify current point balances of the accounts. Once the consumer 102 is registered, the consumer 102 may identify, via the consumer device 103, a number of points for conversion into an investment fund.

The processing server 110 may then convert the points into a monetary value based on one or more conversion rules. As discussed in more detail below, the conversion rules may be set by or based on the program operator 104, the processing server 110, an established exchange rate, or other suitable entity or criteria. In some instances, the conversion rules may be set by an investment institution 112. The investment institution 112 may be a financial institution configured to operate one or more investment funds. The processing server 110 may convert the points into a monetary value and then provide the monetary value to the investment institution 112 for investing into an investment fund. In some embodiments, the processing server 110 may be a part of or operated by or on behalf of the investment institution 112.

The investment institution 112 may then invest the monetary value of the points of the consumer 102 into one or more investment funds, which the investment institution 112 may continue to manage. Methods and systems for the investing of a monetary value into an investment fund and management thereof will be apparent to persons having skill in the relevant art.

Once the consumer 102 wishes to use their reward points, the consumer 102 may use the consumer device 103 to notify the processing server 110 of their desire to withdraw their reward points from the investment fund for use. The processing server 110 may notify the investment institution 112 of the withdrawal request, and the investment institution 112 may withdraw a monetary value corresponding to the original investment made by the consumer 102. The withdrawn value may vary from the original monetary value due to the appreciation or depreciation of the one or more investment funds that the original monetary value may have been added to. The investment institution 112 may provide the withdrawn value to the processing server 110.

The processing server 110 may then convert the withdrawn monetary value back into reward points based on one or more conversion rules. The conversion rules used to convert the withdrawn monetary value into reward points may be the same conversion rules used in the initial conversion of points into currency, or may be different rules, such as similar to currency exchanges where exchange rates may be different for each direction of conversion. Once the withdrawn value has been converted back into points, the processing server 110 may credit the corresponding payment account(s) with the points. In some embodiments, crediting the payment account(s) of the consumer 102 may include notifying the program operator 104 of the newly converted points, which the program operator 104 may then add into corresponding payment account(s). In other embodiments, once the consumer 102 has registered for the service via the consumer device 103, the processing server 110 may operate the rewards for the payment accounts of the consumer 102. Once the points have been credited back to the consumer 102, the consumer 102 may be free to redeem the points or otherwise use them as desired using the consumer device 103 or other suitable method as will be apparent to persons having skill in the relevant art.

The providing of an investment fund for consumer loyalty rewards may provide a number of benefits to the consumer 102, the program operator 104, and the investment institution 112. The consumer 102 may receive a return on points during periods of time that the consumer 102 may otherwise have left their points untouched in an account. The return on points may thus provide the consumer 102 with additional benefits and increased spending power. By providing the ability for the consumer 102 to register with the service and earn a return on points, the program operator 104 may receive increased business by the consumer 102, which may, in turn, increase revenue for the program operator 104. The investment institution 112 may benefit by receiving more money for use in investing, which may increase returns and otherwise increase revenue based on fees and commissions received from investments. Accordingly, the processing server 110 in the system 100 may provide for a significant number of benefits to others in the system 100 via the methods and systems discussed herein.

### Processing Server

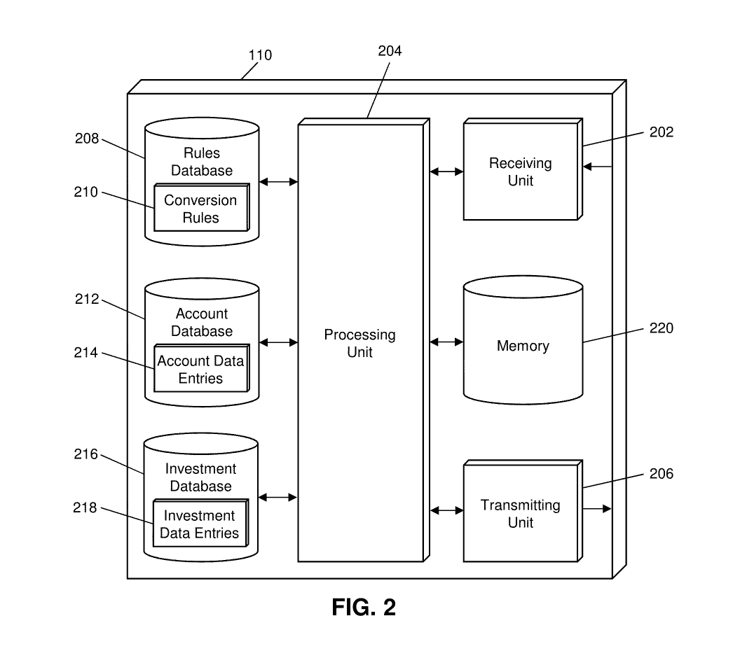

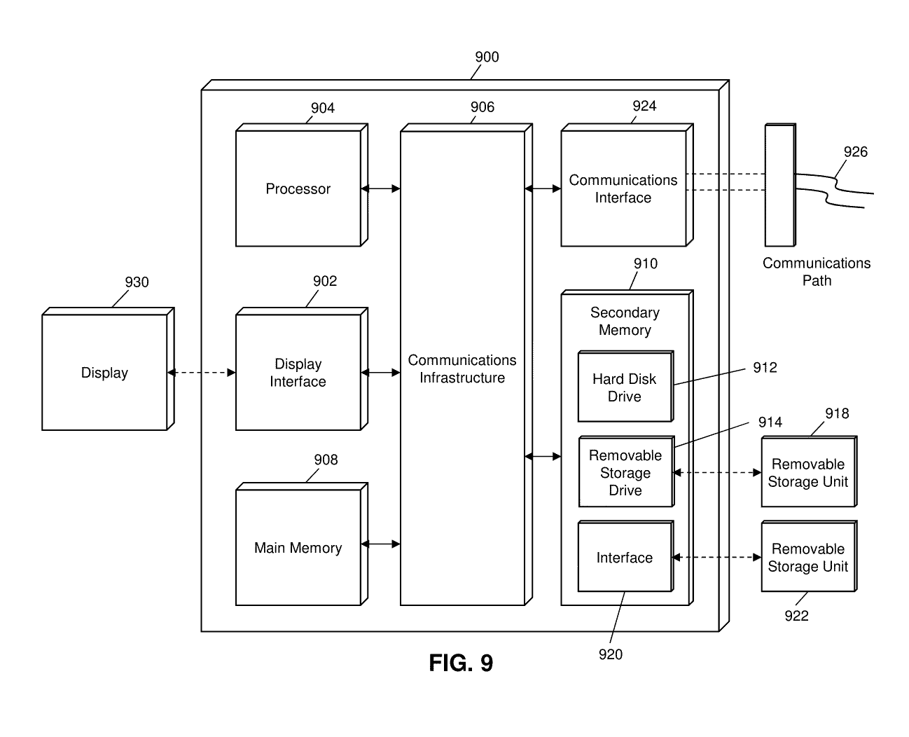

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of processing server 110 suitable for performing the functions as discussed herein. For example, the computer system 900 illustrated in FIG. 9 and discussed in more detail below may be a suitable configuration of the processing server 110.

The processing server 110 may include a receiving unit 202. The receiving unit 202 may be configured to receive data over one or more networks via one or more network protocols. The receiving unit 202 may receiving registration information from the consumer device 103 to register with the service. The registration information may include information identifying one or more payment accounts associated with the consumer 102 for which the consumer 102 earns reward points. Data included in the registration information may include payment account numbers, usernames, passwords, issuer identification information, authentication information, or other suitable data that may be received by the receiving unit 202 via the registration process. The processing server 110 may also include a transmitting unit 206. The transmitting unit 206 may be configured to transmit data over one or more networks via one or more network protocols. The transmitting unit 206 may transmit data regarding the identified payment account(s) to the program operator 104 for authentication, which may be receiving by the receiving unit 202.

Once the account(s) and the consumer 102 have been authenticated, a processing unit 204 of the processing server 110 may store account information for the consumer 102 in an account database 212. The account database 212 may include a plurality of account data entries 214, wherein each account data entry 214 corresponds to a payment account and/or consumer 102. Each account data entry 214 may include an identifier used for identification of the respective account data entry 214 and may also include other information suitable for performing the functions disclosed herein, such as account numbers for registered payment accounts, reward point amounts, consumer preferences, etc.

The receiving unit 202 may also be configured to receive an investment request from the consumer 102. The investment request may include at least an account identifier and a reward amount. The processing unit 204 may identify an account data entry 214 in the account database 212 associated with the consumer 102 where the included identifier corresponds to the account identifier included in the received investment request. The processing unit 204 may be configured to then identify a monetary value of the reward amount specified by the consumer 102 in the investment request.

The reward amount may be identified by the processing unit 204 using one or more conversion rules 210, which may be stored in a rules database 208. Each conversion rule 210 may include at least an identifier used for identification of the respective conversion rule 210 and a conversion rate. The processing unit 204 may be configured to identify one or more conversion rules 210 based on the included identifier and one of: information included in the identified account data entry 214, information associated with the payment account to which the reward points correspond, information associated with the program operator 104 to which the payment account is registered, etc. In some embodiments, such information may be stored in a memory 220 of the processing server 110.

The processing unit 204 may be configured to convert the reward amount indicated in the investment request into a monetary value using the conversion rate included in each of the identified conversion rules 210. The transmitting unit 206 may then transmit the identified monetary value and any other suitable information, such as the identifier of the identified account data entry 214, to the investment institution 112 for investment into an investment fund.

In some embodiments, the processing unit 204 may generate an investment data entry 218 for each investment for storage in an investment database 216 in the processing server 110. The investment data entry 218 may include information regarding the investment, which may be used for management of the investment by the processing server 110 and/or the consumer 104. The investment data entries 218 may each include one or more of: an identifier, such as one associated with an account data entry 214, a monetary value, an investment account number, an identifier associated with the investment institution 112, and other data that may be suitable as will be apparent to persons having skill in the relevant art. In some embodiments, the receiving unit 202 may receive information from the investment institution 112 regarding the investment for storage in the corresponding investment data entry 218 by the processing unit 204. For instance, the receiving unit 202 may receiving updates regarding the balance of the investment of the consumer 102, which may be kept updated in the corresponding investment data entry 218. In some embodiments, the investment database 216 and the account database 212 may be a single database, such as one where each included data entry may include information regarding the reward accounts and investments of a consumer 102.

The receiving unit 202 may also be configured to receive withdrawal requests from the consumer 102 via the consumer device 103. Each withdrawal request may include at least an account identifier in the data comprising the withdrawal request. In some embodiments, the withdrawal request may also include a withdrawal amount. The processing unit 204 may identify an account data entry 214 and/or an investment data entry 218 based on the account identifier included in the withdrawal request. The processing unit 204 may be configured to identify one or more conversion rules 210 and use the conversion rates included therein to calculate a reward amount based on the balance of the corresponding investment fund and/or a withdrawal amount included in the withdrawal request. The processing unit 204 may update the investment data entry 218 and/or account data entry 214 accordingly to indicate the withdrawal of the investment and the addition of the calculated reward amount to the reward points of the consumer 102.

The transmitting unit 206 may be configured to transmit a notification to the consumer 102 indicating the successful conversion of their investment into reward points. The notification may be transmitted to the consumer 102 via a data transmission to the consumer device 103 of the consumer 102, which may present the notification to the consumer 102 via a display screen or other suitable method. The notification may also indicate the number of reward points received and any other suitable information, such as the conversion rate, an updated reward point balance, etc. In some embodiments, the transmitting unit 206 may be configured to transmit the calculated reward amount to the program operator 104 for updating of a corresponding reward account associated with the consumer 102.

### Process for Investing Consumer Loyalty Rewards

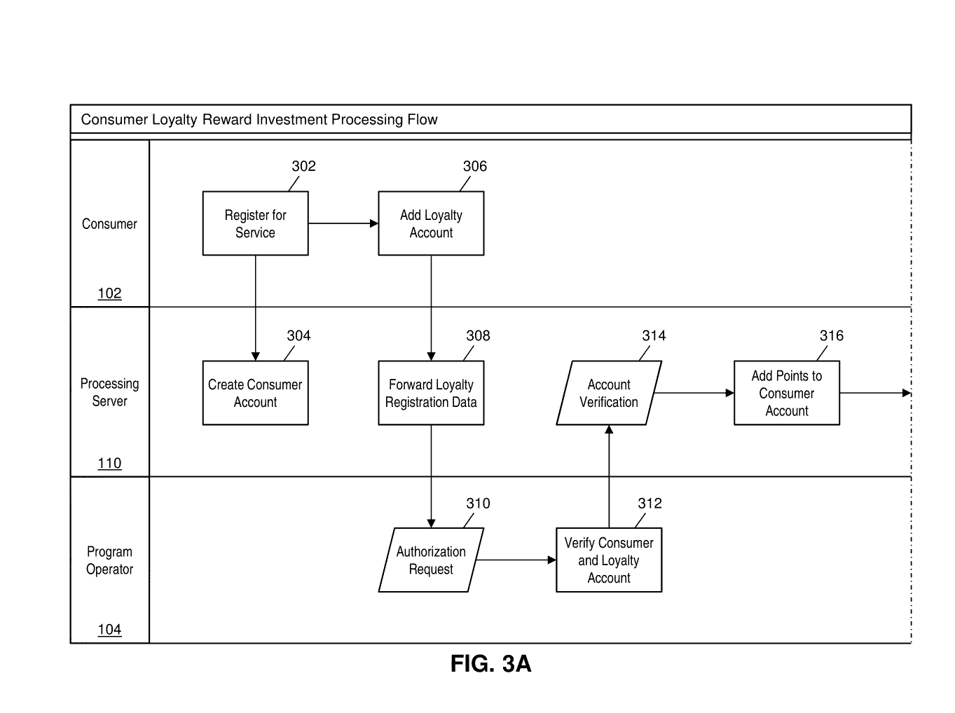

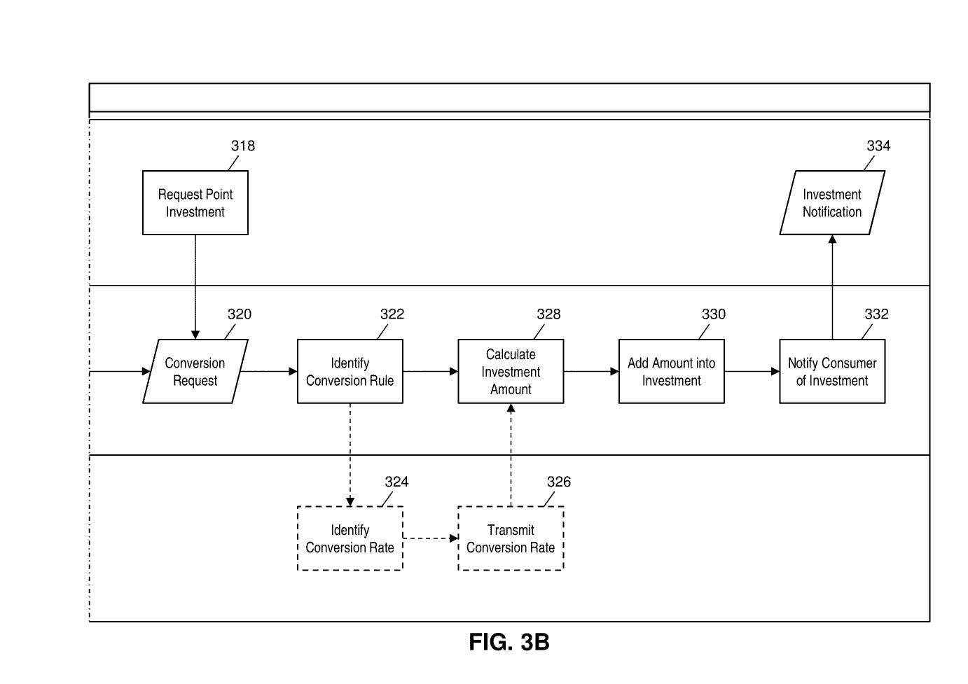

FIGS. 3A and 3B illustrate a process for the investing of consumer loyalty rewards in an investment fund using the system 100 of FIG. 1.

In step 302, the consumer 102 may register for the service provided by the processing server 110 for the investment of loyalty rewards (e.g., reward points) using the consumer device 103. In step 304, the processing server 110 may receive (e.g., via the receiving unit 202) the registration information from the consumer device 103 and may create a consumer account, such as by generating an account data entry 214 in the account database 212. In step 306, the consumer 102 may, using the consumer device 103, add a loyalty account to their account registered with the processing server 110 to be eligible to convert points associated with the account into a monetary value for investment. Adding the loyalty account may include providing authentication information and identification information regarding the account for verification that the consumer 102 is authorized to access the account and its reward points.

In step 308, the processing server 110 may receive the loyalty account registration data, which may be forwarded (e.g., via the transmitting unit 206) to the program operator 104 for authentication. In step 310, the program operator 104 may receive the data as a request for authorization to the indicated loyalty account. In step 312, the program operator 104 may verify the identity of the consumer 102 and the indicated loyalty account using methods and systems that will be apparent to persons having skill in the relevant art. Once the account and consumer are verified, the verification may be transmitted to the processing server 110.

In step 314, the processing server 110 may receive the verification of the consumer 102 and the indicated loyalty account. In step 316, the processing server 110 may add the points for the verified loyalty account into the account data entry 214 associated with the consumer 102, which may thereby make the included points available for conversion into an investment. In step 318, the consumer 102 may submit a request for points investment using the consumer device 103. The request for points investment may include at least the identifier associated with the account and a reward amount. In step 320, the processing server 110 may receive the request.

In step 322, the processing unit 204 of the processing server 110 may identify a conversion rule 210 to be used to convert the points into a monetary value. In some embodiments, the conversion rule 210 may be based on the account data entry 214 associated with the consumer 102. In some instances, the processing server 110 may request a conversion rate from the program operator 104 as indicated in the identified conversion rule 210. In such an instance, the program operator 104 may identify the conversion rate for reward points for the consumer account, in step 324. In step 326, the program operator 104 may transmit the conversion rate to the processing server 110 for use in converting the reward points. It will be apparent to persons having skill in the relevant art that steps 324 and 326 may be optional and may not be performed if the conversion rule 210 includes a conversion rate to be used.

In step 328, the processing unit 204 of the processing server 110 may calculate a monetary value for investment based on the conversion rate included in the conversion rule 210 (e.g., as received from the program operator 104). In step 330, the processing server 110 may add the corresponding monetary value in an investment fund on behalf of the consumer 102. In some embodiments, adding the monetary value into the investment fund may include transmitting the monetary value to the investment institution 112 for inclusion in an investment fund. The adding of the monetary value into the investment may also include the updating of the account data entry 214 associated with the consumer 102 or an investment data entry 218 associated with the consumer 102 to indicate the monetary amount invested by the consumer 102.

In step 332, the processing server 110 may transmit a notification of the investment to the consumer 102 via the consumer device 103. The consumer 102 may receive (e.g., via the consumer device 103) the notification in step 334, which may be displayed to the consumer 102 via a display screen of the consumer device 103. The notification may include an indication that the investment was successful, and may further include other suitable information, such as the amount of the added investment, a total invested amount, the conversion rate used to calculate the investment, details regarding the investment fund, etc.

Process for Converting an Investment into Loyalty Rewards

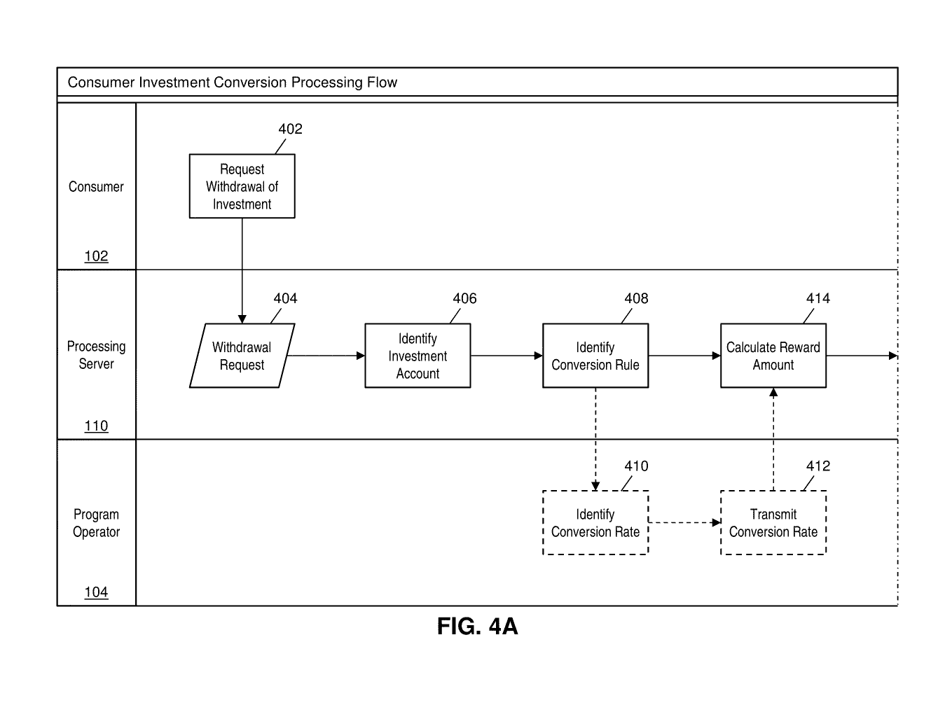

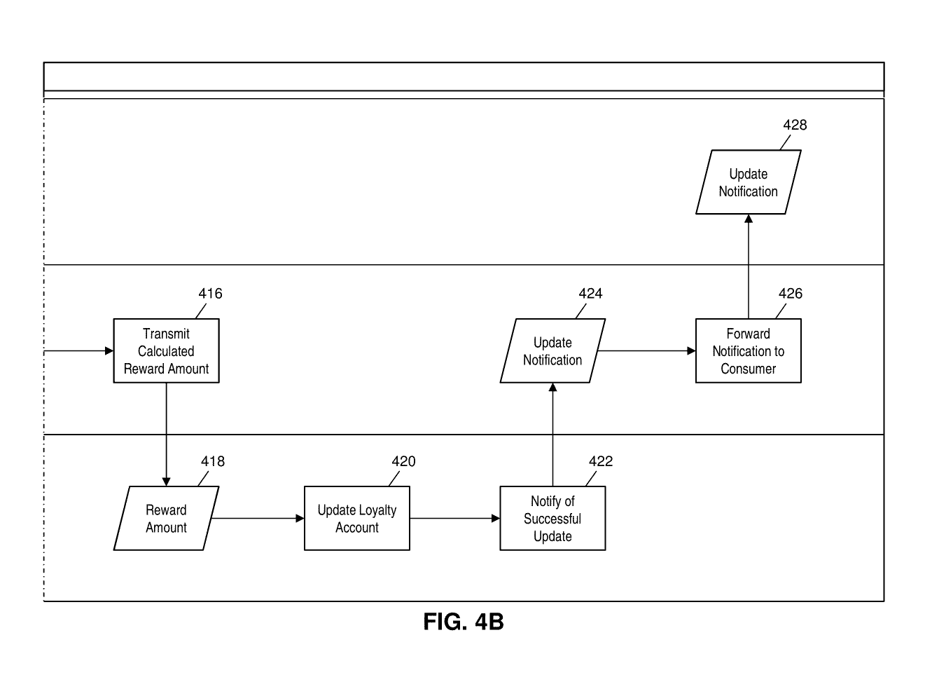

FIGS. 4A and 4B illustrate a process for the conversion of an investment fund into loyalty rewards using the system 100 of FIG. 1.

In step 402, the consumer 102 may request, via the consumer device 103, withdrawal of their investment in the investment fund. In step 404, the processing server 110 may receive (e.g., via the receiving unit 202) the withdrawal request, which may include at least an account identifier. In some embodiments, the withdrawal request may also specify a withdrawal amount. In other embodiments, the withdrawal request may be a request to fully withdraw an investment. In step 406, the processing server 110 may identify (e.g., via the processing unit 204) an account data entry 214 in the account database 212 or an investment data entry 218 in the investment database 216 corresponding to the consumer 102 where the included identifier corresponds to the account identifier included in the received withdrawal request.

In step 408, the processing server 110 may identify a conversion rule 210 in the conversion database 208 for converting the monetary value of the investment into reward points. The conversion rule 210 may be identified based on information included in the identified account data entry 214 and/or investment data entry 218 or other information, such as based on the size of investment, size of withdrawal, the program operator 104, the consumer 102, the currency of the investment, currency exchange rates, and other considerations as will be apparent to persons having skill in the relevant art. In some embodiments, the conversion rule 210 may include a conversion rate. In other embodiments, the conversion rule 210 may indicate that a current conversion rate is to be requested from the program operator 104 associated with the corresponding loyalty account. In such an embodiment, the processing server 110 may request the conversion rate from the program operator 104, which may be identified in step 410. In step 412, the program operator 104 may transmit the identified conversion rate to the processing server 110. It will be apparent to persons having skill in the relevant art that steps 410 and 412 may be optional steps.

In step 414, the processing server 110 may calculate a reward amount based on the monetary value of the investment or the withdrawal amount and the conversion rate. In step 416, the processing server 110 may transmit (e.g., via the transmitting unit 206) the calculated reward amount to the program operator 104. In step 418, the program operator 104 may receive the calculated reward amount and, in step 420, may update the points in the corresponding loyalty account of the consumer 102 to include the newly converted points based on the calculated reward amount. In step 422, the program operator 104 may transmit a notification to the processing server 110 indicating that the updating of the consumer loyalty account was successful.

In step 424, the processing server 110 may receive the notification of the successful updating of the loyalty account. It will be apparent to persons having skill in the relevant art that, in embodiments where the processing server 110 manages the rewards for registered loyalty accounts, steps 418 and 422 may be optional and step 420 may be performed by the processing unit 204 of the processing server 110 on the account data entry 214 associated with the consumer 102.

In step 426, the processing server 110 may forward a notification of the successful updating of the reward points of the loyalty account to the consumer 102 via the consumer device 103. In step 428, the consumer 102 may receive (e.g., using the consumer device 103) the notification, which may be displayed to the consumer 102 on a display screen of the consumer device 103. In some instances, the notification may further include the total reward amount, the amount converted from the investment, and/or the conversion rate.

Method for Converting Consumer Rewards to and from an Investment Fund

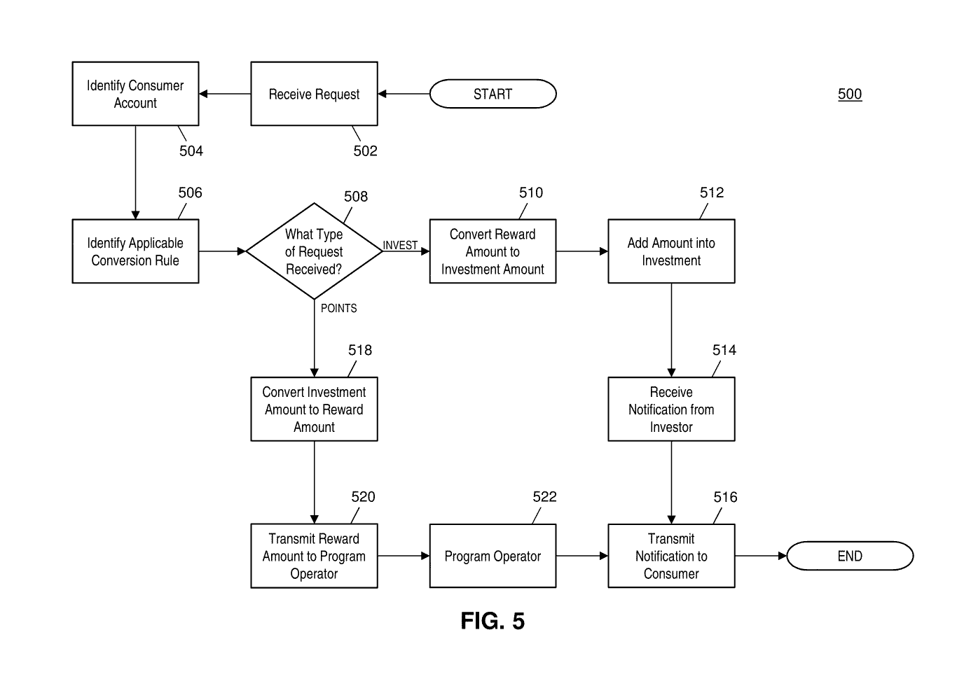

FIG. 5 illustrates a method 500 for the converting of consumer loyalty reward points to and from an investment fund using the processing server 110.

In step 502, the receiving unit 202 of the processing server 110 may receive a request from the consumer 102 via the consumer device 103. The request may be comprised of data which may include at least an account identifier associated with the consumer 102 and may indicate that the request is for the investing of points or withdrawal of points. In some embodiments, the request may also indicate the amount of points and/or monetary value that is to be invested or withdrawn. In step 504, the processing unit 204 of the processing server 110 may identify an account data entry 214 and/or investment data entry 218 associated with the consumer 102 where the included identifier corresponds to the account identifier included in the received request.

In step 506, the processing unit 204 may identify an applicable conversion rule 210 in the conversion database 208. In some embodiments, the conversion rule 210 may be identified based on an identifier included in the conversion rule 210 corresponding to an identifier included in the identified account data entry 214 and/or investment data entry 218. In step 508, the processing unit 204 may identify if the request is a request to invest or a request to convert an investment into reward points.

If the request is a request to invest, then, in step 510, the processing unit 204 may convert reward points into a monetary value for investment using the conversion rate included in the identified conversion rule 210. The amount of reward points converted may be based on the reward points indicated in the identified account data entry 214 or may be based on a reward amount included in the received request. In step 512, the transmitting unit 206 of the processing server 110 may transmit the monetary value to the investment institution 112 for including in an investment fund on behalf of the consumer 102. In embodiments where the processing server 110 may manage investments, step 512 may include the investing of the monetary value in the investment fund directly. In step 514, the receiving unit 202 may receive a notification from the investment institution 112 (e.g., or the processing unit 204 may generate the notification) indicating the successful investment into the investment fund. In step 516, the notification may be forwarded to the consumer 102 via the consumer device 103.

If, in step 508, the processing unit 204 determined the request to be a request to convert an investment into reward points, then, in step 518, the processing unit 204 may calculate a reward amount based on the investment amount. The investment amount may be based on the investment of the consumer 102 (e.g., indicated in the investment data entry 218) or may be based on an investment amount included in he received request. In step 520, the transmitting unit 206 may transmit the calculated reward amount to the program operator 104 for depositing into the corresponding loyalty account. In embodiments where the processing server 110 may manage the loyalty account, step 520 may include storing the calculated reward amount in the loyalty account, such as in the identified account data entry 214. In step 522, the receiving unit 202 may receive a notification from the program operator 104 (e.g., or the processing unit 204 may generate the notification) indicating the successful depositing of the reward amount in the loyalty account. In step 516, the notification may be forwarded to the consumer 102 via the consumer device 103.

### Graphical User Interface

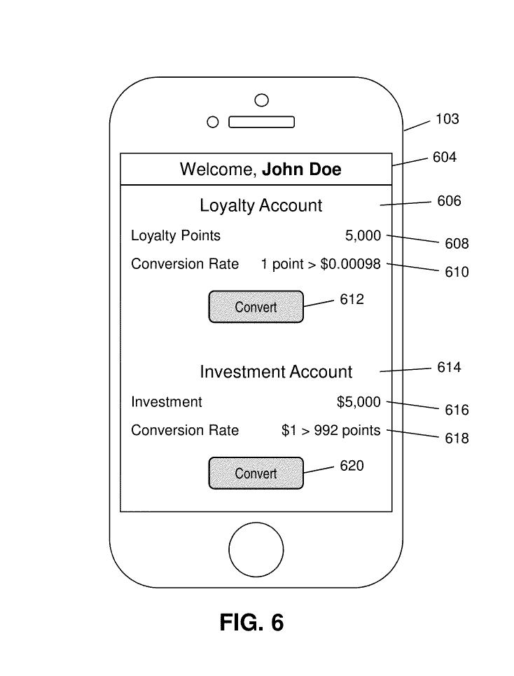

FIG. 6 illustrates a graphical user interface of the consumer device 103 for the investing of reward points and into an investment fund and conversion thereof back into reward points by a consumer 102. It will be apparent to persons having skill in the relevant art that the example illustrated in FIG. 6 is one possible configuration of a graphical user interface and that additional configurations may be possible.

As illustrated in FIG. 6, the consumer 102 may use the consumer device 103 or any other suitable computing device (e.g., a desktop computer, notebook computer, laptop computer, tablet, smartphone, etc.) to access the graphical user interface illustrated and described herein. The consumer device 103 may include a display 604. The display 604 may be configured to display an account screen. The account screen may be access via a webpage, an application program executed by the consumer device 103, or any other suitable method as will be apparent to persons having skill in the relevant art.

The account screen may include loyalty account details 606. The loyalty account details 606 may show information regarding the status of one or more loyalty accounts for the consumer 102 and conversion thereof into an investment fund. In the example illustrated in FIG. 6, the loyalty account details 606 may include a point amount 608 and a point conversion rate 610. The point amount 608 may be an amount of reward points currently in the loyalty account of the consumer 102 that may be eligible for investing into an investment fund. The point conversion rate 610 may be a conversion rate for reward points into a monetary value for investment in the investment fund. In the illustrated example, the consumer 102, John Doe, has 5,000 loyalty points eligible for conversion at a rate of $0.00098 for each point.

The account screen may further include a point conversion button 612. The point conversion button 612, when interacted with by the consumer 102, may initiate the investing of reward points in the investment fund, such as via the submission of a request to invest to the processing server 110 as illustrated in the method 500 of FIG. 5. In some embodiments, the point conversion button 612 may be accompanied by a data field or other input method that may be used by the consumer 102 to indicate a number of points from the available point amount 608 to be invested.

The account screen may also include investment account details 614. The investment account details 614 may show information regarding the status of one or more investment funds for the consumer 102 and conversion thereof into reward points. In the example illustrated in FIG. 6, the investment account details 614 may include an investment amount 616 and an investment conversion rate 618. The investment amount 616 may be the monetary amount of the investment currently in the investment account of the consumer 102 that may be eligible for withdrawal as reward points. The investment conversion rate 618 may be a conversion rate for the investment into reward points for depositing into the loyalty account. In the illustrated example, the consumer 102 has $5,000 in the investment fund eligible for conversion at 992 points for each $1 withdrawn.

The account screen may further include an investment conversion button 620. The investment conversion button 620, when interacted with by the consumer 102, may initiate the withdrawal of an investment for conversion into reward points, such as via the submission of a request to convert investment to reward points to the processing server 110 as illustrated in the method 500 of FIG. 5. In some embodiments, the investment conversion button 620 may be accompanied by a data field or other input method that may be used by the consumer 102 to the withdrawal amount from the available investment amount 616 to be invested.

### Exemplary Method for Investing Consumer Loyalty Rewards

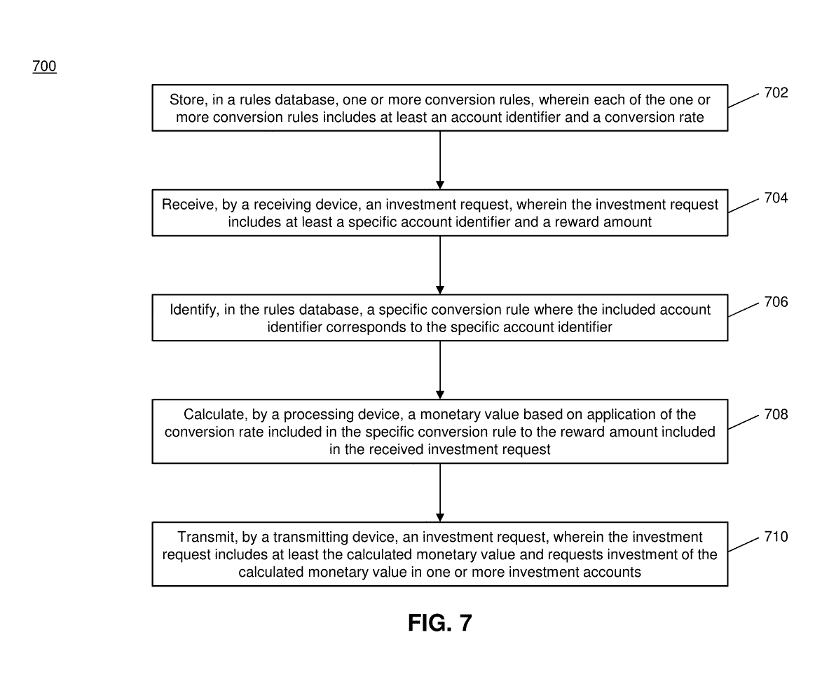

FIG. 7 illustrates an exemplary method 700 for the investing of consumer loyalty rewards in an investment fund.

In step 702, one or more conversion rules (e.g., conversion rules 210) may be stored in a rules database (e.g., the rules database 208), wherein each of the one or more conversion rules 210 includes at least an account identifier and a conversion rate. In step 704, an investment request may be received by a receiving device (e.g., the receiving unit 202), wherein the investment request includes at least a specific account identifier and a reward amount. In step 706, a specific conversion rule 210 may be identified, in the rules database 208, where the included account identifier corresponds to the specific account identifier.

In step 708, a monetary value may be calculated, by a processing device (e.g., the processing unit 204), based on application of the conversion rate included in the specific conversion rule 210 to the reward amount included in the received investment request. In step 710, an investment request may be transmitted by a transmitting device (e.g., the transmitting unit 206), wherein the investment request includes at least the calculated monetary value and requests investment of the calculated monetary value in one or more investment accounts. In some embodiments, the transmitted investment request may further include the specific account identifier.

In one embodiment, the method 700 may further include storing, in an investment database (e.g., the investment database 216), an investment data entry (e.g., investment data entry 218), wherein the investment data entry 218 includes data related to an investment including at least the specific account identifier and the calculated monetary value. In a further embodiment, the stored investment data entry 218 may further include the one or more investment accounts.

In some embodiments, the method 700 may further include: transmitting, after a period of time, a withdrawal request, wherein the withdrawal request includes at least the specific account identifier and requests withdrawal of a corresponding investment; and receiving, by the receiving device 202, an invested amount based on the corresponding investment. In a further embodiment, the method 700 may even further include: calculating, by the processing device 204, an updated reward amount based on application of the conversion rate included in the specific conversion rule 210 to the received invested amount; and transmitting, by the transmitting device 206, the updated reward amount. In an even further embodiment, the updated reward amount may be transmitted in response to a received request for conversion including at least the specific account identifier.

### Exemplary Method for Converting an Investment to Consumer Loyalty Rewards

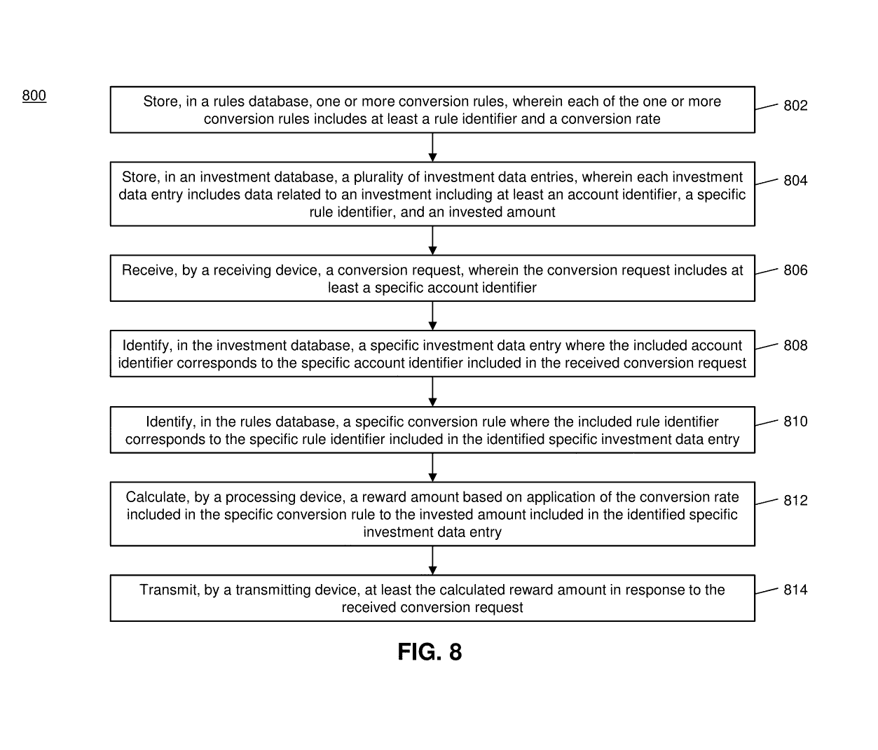

FIG. 8 illustrates an exemplary method 800 for the conversion of an investment in one or more investment funds to consumer loyalty rewards.

In step 802, one or more conversion rules (e.g., conversion rules 210) may be stored in a rules database (e.g., the rules database 208), wherein each of the one or more conversion rules 210 includes at least a rule identifier and a conversion rate. In step 804, a plurality of investment data entries (e.g., investment data entries 218) may be stored in an investment database (e.g., the investment database 216), wherein each investment data entry 218 includes data related to an investment including at least an account identifier, a specific rule identifier, and an invested amount. In one embodiment, the specific rule identifier and the account identifier may be a single value.

In step 806, a conversion request may be received by a receiving device (e.g., the receiving unit 202), wherein the conversion request includes at least a specific account identifier. In step 808, a specific investment data entry 218 may be identified, in the investment database 216, where the included account identifier corresponds to the specific account identifier included in the received conversion request. In step 810, a specific conversion rule 210 may be identified, in the rules database 208, where the included rule identifier corresponds to the specific rule identifier included in the identified specific investment data entry 218.

In step 812, a reward amount may be calculated, by a processing device (e.g., the processing unit 204), based on application of the conversion rate included in the specific conversion rule 210 to the invested amount included in the identified specific investment data entry 218. In one embodiment, the conversion request may further include a conversion amount, the conversion amount may be less than the invested amount, and the calculated reward amount may be based on application of the conversion rate included in the identified specific conversion rule 210 to the conversion amount included in the identified specific investment data entry 218. In step 814, at least the calculated reward amount may be transmitted, by a transmitting device (e.g., the transmitting unit 206), in response to the received conversion request.

### Computer System Architecture

FIG. 9 illustrates a computer system 900 in which embodiments of the present disclosure, or portions thereof, may be implemented as computer-readable code. For example, the consumer device 103 and the processing server 110 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4A, 4B, 5, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3A, 3B, 4A, 4B, 5, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for investing consumer loyalty rewards and converting an investment to consumer loyalty rewards. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for investing consumer loyalty rewards, comprising:
storing, in a rules database, one or more conversion rules, wherein each of the one or more conversion rules includes at least an account identifier and a conversion rate;
receiving, by a receiving device, an investment request, wherein the investment request includes at least a specific account identifier and a reward amount;
identifying, in the rules database, a specific conversion rule where the included account identifier corresponds to the specific account identifier;
calculating, by a processing device, a monetary value based on application of the conversion rate included in the specific conversion rule to the reward amount included in the received investment request; and
transmitting, by a transmitting device, an investment request, wherein the investment request includes at least the calculated monetary value and requests investment of the calculated monetary value in one or more investment accounts.

2. The method of claim 1, further comprising:
storing, in an investment database, an investment data entry, wherein the investment data entry includes data related to an investment including at least the specific account identifier and the calculated monetary value.

3. The method of claim 2, wherein the stored investment data entry further includes the one or more investment accounts.

4. The method of claim 1, wherein the transmitted investment request further includes the specific account identifier.

5. The method of claim 4, further comprising:
transmitting, after a period of time, a withdrawal request, wherein the withdrawal request includes at least the specific account identifier and requests withdrawal of a corresponding investment; and
receiving, by the receiving device, an invested amount based on the corresponding investment.

6. The method of claim 5, further comprising:
calculating, by the processing device, an updated reward amount based on application of the conversion rate included in the specific conversion rule to the received invested amount; and
transmitting, by the transmitting device, the updated reward amount.

7. The method of claim 6, wherein the updated reward amount is transmitted in response to a received request for conversion, the request for conversion including at least the specific account identifier.

8. A method for converting an investment to consumer loyalty rewards, comprising:
storing, in a rules database, one or more conversion rules, wherein each of the one or more conversion rules includes at least a rule identifier and a conversion rate;
storing, in an investment database, a plurality of investment data entries, wherein each investment data entry includes data related to an investment including at least an account identifier, a specific rule identifier, and an invested amount;
receiving, by a receiving device, a conversion request, wherein the conversion request includes at least a specific account identifier;
identifying, in the investment database, a specific investment data entry where the included account identifier corresponds to the specific account identifier included in the received conversion request;
identifying, in the rules database, a specific conversion rule where the included rule identifier corresponds to the specific rule identifier included in the identified specific investment data entry;
calculating, by a processing device, a reward amount based on application of the conversion rate included in the identified specific conversion rule to the invested amount included in the identified specific investment data entry; and
transmitting, by a transmitting device, at least the calculated reward amount in response to the received conversion request.

9. The method of claim 8, wherein the specific rule identifier and the account identifier are a single value.

10. The method of claim 8, wherein
the conversion request further includes a conversion amount,
the conversion amount is less than the invested amount, and
the calculated reward amount is based on application of the conversion rate included in the identified specific conversion rule to the conversion amount included in the identified specific investment data entry.

11. A system for investing consumer loyalty rewards, comprising:
a rules database configured to store one or more conversion rules, wherein each of the one or more conversion rules includes at least an account identifier and a conversion rate;
a receiving device configured to receive an investment request, wherein the investment request includes at least a specific account identifier and a reward amount;
a processing device configured to
identify, in the rules database, a specific conversion rule where the included account identifier corresponds to the specific account identifier, and
calculate a monetary value based on application of the conversion rate included in the specific conversion rule to the reward amount included in the received investment request; and
a transmitting device configured to transmit an investment request, wherein the investment request includes at least the calculated monetary value and requests investment of the calculated monetary value in one or more investment accounts.

12. The system of claim 11, further comprising:
an investment database configured to store an investment data entry, wherein the investment data entry includes data related to an investment including at least the specific account identifier and the calculated monetary value.

13. The system of claim 12, wherein the stored investment data entry further includes the one or more investment accounts.

14. The system of claim 11, wherein the transmitted investment request further includes the specific account identifier.

15. The system of claim 14, wherein
the transmitting device is further configured to transmit, after a period of time, a withdrawal request, wherein the withdrawal request includes at least the specific account identifier and requests withdrawal of a corresponding investment, and
the receiving device is further configured to receive an invested amount based on the corresponding investment.

16. The system of claim 15, wherein
the processing device is further configured to calculate an updated reward amount based on application of the conversion rate included in the specific conversion rule to the received invested amount, and
the transmitting device is further configured to transmit the updated reward amount.

17. The system of claim 16, wherein the updated reward amount is transmitted in response to a received request for conversion, the request for conversion including at least the specific account identifier.

18. A system for converting an investment to consumer loyalty rewards, comprising:
a rules database configured to store one or more conversion rules, wherein each of the one or more conversion rules includes at least a rule identifier and a conversion rate;
an investment database configured to store a plurality of investment data entries, wherein each investment data entry includes data related to an investment including at least an account identifier, a specific rule identifier, and an invested amount;
a receiving device configured to receive a conversion request, wherein the conversion request includes at least a specific account identifier;
a processing device configured to
identify, in the investment database, a specific investment data entry where the included account identifier corresponds to the specific account identifier included in the received conversion request,
identify, in the rules database, a specific conversion rule where the included rule identifier corresponds to the specific rule identifier included in the identified specific investment data entry, and
calculate a reward amount based on application of the conversion rate included in the identified specific conversion rule to the invested amount included in the identified specific investment data entry; and
a transmitting device configured to transmit at least the calculated reward amount in response to the received conversion request.

19. The system of claim 18, wherein the specific rule identifier and the account identifier are a single value.

20. The system of claim 18, wherein
the conversion request further includes a conversion amount,
the conversion amount is less than the invested amount, and
the calculated reward amount is based on application of the conversion rate included in the identified specific conversion rule to the conversion amount included in the identified specific investment data entry.
